(19) United States
(12) Patent Application Publication
(10) Pub. No.: US 2016/0274997 A1
(43) Pub. Date: Sep. 22, 2016

(54) END USER MONITORING TO AUTOMATE ISSUE TRACKING

(71) Applicant: HEWLETT PACKARD ENTERPRISE DEVELOPMENT LP, Houston, TX (US)

(72) Inventors: Noam Kachko, Yehud (IL); Orit Orit Sharon, Yehud (IL); Ilana Kupershmidt, Yehud (IL)

(21) Appl. No.: 15/032,783

(22) PCT Filed: Jan. 29, 2014
(86) PCT No.: PCT/US2014/013600

§ 371 Date: Apr. 28, 2016

(51) Int. Cl. G06F 11/36; G06F 9/44

(52) U.S. Cl. CPC G06F 11/3636; G06F 11/3664; G06F 8/70

(57) ABSTRACT

Example embodiments relate to end user monitoring to automate issue tracking. In example embodiments, an application is monitored during production to collect real user data. In response to detecting an error in the real user data, source code files in a source management system that are associated with is obtained. At this stage, a notification of the error is sent to a development participant that is responsible for one of the source code files, where the notification includes the code coverage for the file.

### BACKGROUND

Software applications are typically capable of detecting errors and then collecting data related to the errors. In sonic cases, the error data may be automatically submitted to the makers of the software, where the error data is then manually processed to determine if the error corresponds to an actual issue with the application. For example, a software tester may use the error data to attempt to replicate the error in a test environment. If the error is confirmed to be an actual issue, an issue entry that includes some or all of the error data may be created in an issue tracking system by the tester.

### BRIEF DESCRIPTION OF THE DRAWINGS

The following detailed description references the drawings, wherein:

FIG. 1 is a block diagram of an example system for end user monitoring to automate issue tracking;

FIG. 2 is a block diagram of an example computing device including modules for performing aspects of end user monitoring to automate issue tracking;

FIG. 3 is a flowchart of an example method for execution by a computing device for end user monitoring to automate issue tracking; and

FIG. 4 is a flowchart of an example method for execution by a computing device for end user monitoring to automate issue tracking of a compiled software application.

### DETAILED DESCRIPTION

As discussed above, error data can be automatically collected for processing by software testers. The error data typically includes a stack trace that provides information describing the current function calls in the software application. Further, the error data is manually verified before entries are created in an issue tracking system. However, the error data and the issue entry do not include a development context (i.e., affected source code files, check-in information, code coverage, or other information from development systems) for the error or exception. Further, because the development participant (e.g., software developer, software engineer, information technology technician, software architect, etc.) responsible for the development context is not automatically identified, there is a delay in providing the error data to the person responsible for addressing the issue so that the error data can be manually processed.

Example embodiments disclosed herein perform end user monitoring to automate issue tracking. For example, in some embodiments, an application is monitored during production to collect real user data. In response to detecting an error in the real user data, source code files in a source management system that are associated with the error are determined. A code coverage value for each of the source code files is obtained. At this stage, a notification of the error is sent to a development participant that is responsible for one of the source code files, where the notification includes the code coverage for the file.

In this manner, example embodiments disclosed herein allow automated issue tracking by monitoring and user data. Specifically, by analyzing end user data and connecting the data to source management systems, an issue entry with a development context (e.g., build information, source code files, build time, development participants, etc.) may be automatically created in an issue tracking system, where the relevant development participants are also notified of the development context and issue entry. Accordingly, time and money that are wasted on support and escalation management is saved by (1) automatically finding an incident in production and correctly classifying it and its significance in real time and (2) by directing the issue to the most relevant person. By analyzing logs flows such as error flows and connecting the flows to development artifacts such as a source management system (SCM) change, build information, feature, etc., an open incident for production issues may be created in real time. The open incident will contain relevant data with the development context that is needed by the development participant to resolve the issue. From the development context, the development participant may deduce the importance and frequency of the issue.

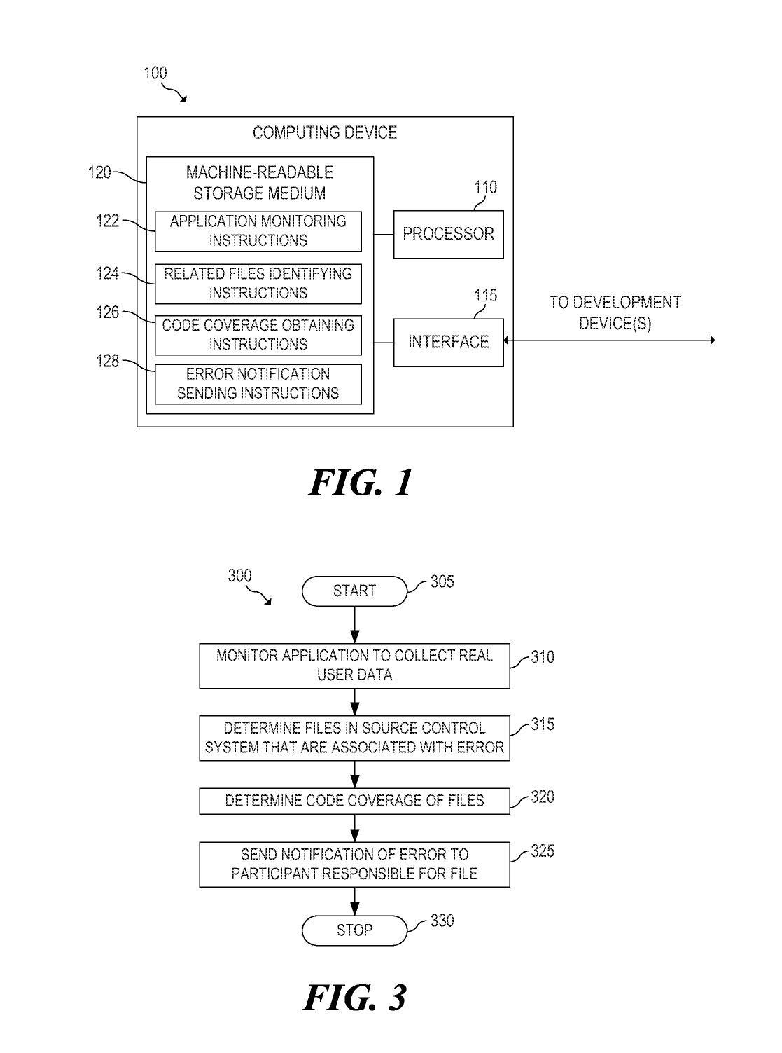

Referring now to the drawings, FIG. 1 is a block diagram of an example system for end user monitoring to automate issue tracking. The example system can be implemented as a computing device 100 such as a server, a notebook computer, a desktop computer, an all-in-one system, a tablet computing device, or any other electronic device suitable for end user monitoring to automate issue tracking. In the embodiment of FIG. 1, computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to enable end user monitoring to automate issue tracking. As an alternative or in addition to retrieving and executing instructions, processor 110 may include one or more electronic circuits comprising a number of electronic components for performing the functionality of one or more of instructions 122, 124, 126, 128.

Interface 115 may include a number of electronic components for communicating with client device(s). For example, interface 115 may be an Ethernet interface, a Universal Serial Bus (USB) interface, an IEEE 1394 (FireWire) interface, an external Serial Advanced Technology Attachment (eSATA) interface, or any other physical connection interface suitable for communication with development devices (e.g., source management system systems, issue tracking systems, project management system, etc.). Alternatively, interface 115 may be a wireless interface, such as a wireless local area network (WLAN) interface or a near-field communication (NFC) interface. In operation, as detailed below, interface 115 may be used to send and receive data, such as source management data, issue tracking data, or notification data, to and from a corresponding interface of a development device.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for end user monitoring to automate issue tracking.

Application monitoring Instructions 122 may monitor the execution of a software application in production to obtain error data. The error data may include stack traces and/or error flows of the software application. A stack trace describes the active stack frames for a particular point in time during the execution of the software application, where each stack frame corresponds to a call to a function that has yet to terminate with a return. An error flow is a flow of execution that results in an error (i.e., exception), where error information (e.g., stack trace, exception details, etc.) is collected when the error occurs. A software application may include exception handling to detect and then handle errors as specified by the development participants (e.g., software developer, software engineer, information technology technician, software architect, etc.) of the software application.

A software application may be software or a service provided by computing device 100 to client devices over a network (e.g., Internet, Intranet, etc.). For example, a software application may be executed by a web server executing on computing device 100 to provide web pages to a web browser of a client device, In another example, a software application may be a web service that provides functionality in response to requests from a client device over a network. As end users interact with the software application, the error data may be collected in response to detected errors that are triggered by the end users' actions.

Related files identifying instructions 124 may identify source code files that are related to an error in the error data. For example, based on the stack trace, source code files including the functions in the stack trace may be identified as being related to the error. In this example, the source code files may be identified using a source management system (SCM) system, which provides an application programming interface (API) that is accessible to computing device 100. The API may also allow related files identifying instructions 124 to retrieve information about check-in events of the source code files. In this case, the check-in event information can be used to identify the development participants that committed changes to the source code files that are included in the current build of the software application.

Code coverage obtaining instructions 126 may determine the code coverage of each of the source code files. The code coverage of a source code file may be the proportion of code within the source code file that has been executed during automated testing of the software application. In some cases, code coverage of each of the source code files may be obtained from the API of the SCM system, where the SCM system includes modules for performing automated testing. Alternatively, a separate automated testing system may be consulted for the code coverage values.

Error notification sending instructions 128 may send a notification of the error to the development participants responsible for the source code files. The notification may include the error data, the check-in event information, and the code coverage of each of the source code files. For example, the notification may be transmitted via email to an email address of a development participant that is obtained from the SCM system. In another example, the notification may be created as an incident in an issue tracking system, which in turn notifies the responsible development participants of the new incident, The development participants may then review the incident along with the relevant development context (e.g., stack trace, check-in event information, source code files, etc.).

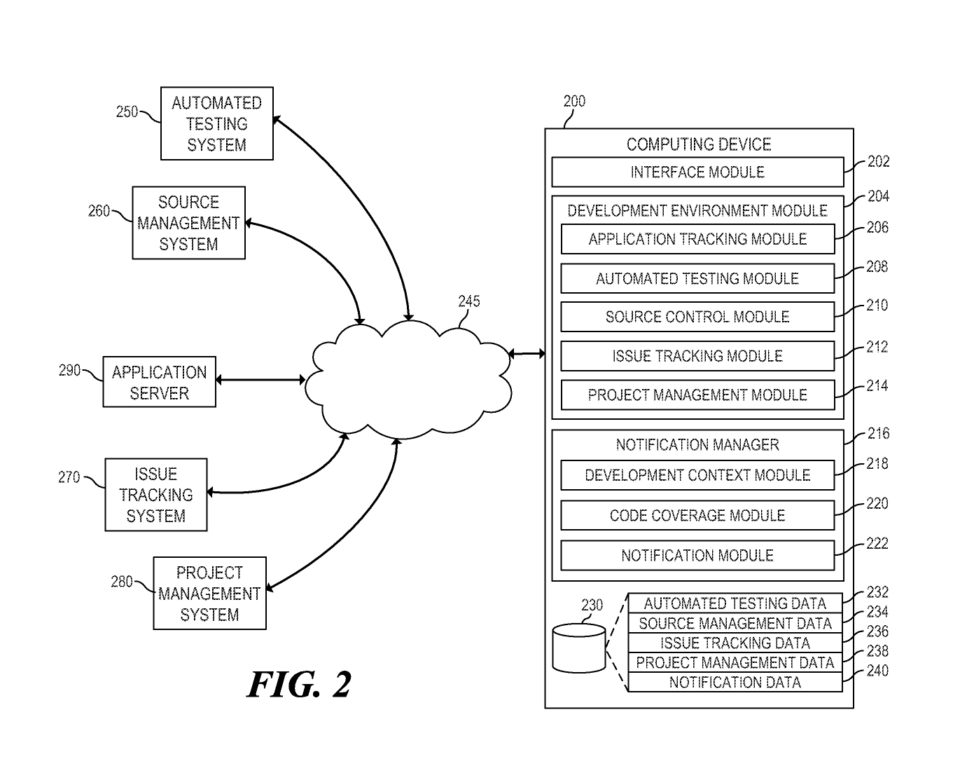

FIG. 2 is a block diagram of an example computing device 200 in communication via a network 245 with automated testing system 250, source management system 260, issue tracking system 270, and project management system 280. As illustrated in FIG. 2 and described below, computing device 200 may communicate with the aforementioned development systems to provide end user monitoring to automate issue tracking.

Application server 290 may be configured to provide a server software application to client devices. The application may be provided as thin or thick client software, web pages, or web services over a network. The application server 290 may provide the application based on source code (e.g., HTML files, script files, etc.) or object code (e.g., linked libraries, shared objects, executable files, etc.) generated from source code. For example, the application server 290 may provide web pages based on HTML files, which may include embedded scripts that are executed by the application server 290 to generate dynamic content for the client devices. In another example, the application server 290 may expose an interface to a web service that triggers execution of a function in a linked library in response to receiving a request from a client device.

As illustrated, computing device 200 may include a number of modules 202-220. Each of the modules may include a series of instructions encoded on a machine-readable storage medium and executable by a processor of the computing device 200. In addition or as an alternative, each module may include one or more hardware devices including electronic circuitry for implementing the functionality described below.

As with server computing device 100 of FIG. 1, computing device 200 may be a database server, file server, desktop computer, or any other device suitable for executing the functionality described below. As detailed below, computing device 200 may include a series of modules 202-222 for end user monitoring to automate issue tracking.

Interface module 202 may manage communications with the development systems 250, 260, 270, 280 and application server 290. Specifically, the interface module 202 may obtain data such as testing logs, source management data, issue data, etc. from the development systems 250, 260, 270, 280 and error data from application server 290. Interface module 202 may also manage credentials for accessing the development systems 250, 260, 270, 280 and application server 290. Specifically, interface module 202 may provide credentials to the development systems 250, 260, 270, 280 and application server 290 and request access to data.

Development environment module 204 may manage development environments for software applications. Although the components of development environment module 204 are described in detail below, additional details regarding an example implementation of module 204 are provided above in connection with instructions 122-124 of FIG. 1.

The development environment of a software application may describe the various characteristics of a particular build of the software application. The characteristics may include automated testing logs, check-in information for source code files, reported issues of the application, and project milestones, The development environment allows for an automated analysis of the current build to be performed and related to real-time application data such as end user monitoring.

Application tracking module 206 may monitor the execution of an application provided by application server 290. Specifically, application tracking module 206 may monitor the application server 290 for error data. For example, exceptions may be detected by the application server 290, which captures error data related to the exception for providing to application tracking module 206. In this example, users of the application may be presented with a notification that an error report is being captured by application server 290.

Automated testing module 208 may interact with automated testing system 250 to obtain automated testing data. Automated testing data may include log and/or reports that describe the results of automated testing performed on an application provided by application server 290. For example, automated testing system 250 may execute automated testing scripts to identify issues during the execution of the application in a test environment. In this example, automated testing system 250 may trace execution of the application to determine code coverage of the various source code files used to compile the application. Based on error data obtained as described above, automated testing module 208 may obtain automated testing data from automated testing system 250 that is relevant to source code files associated with a particular error that is described in the error data. The automated testing data 232 may be stored in storage device 230.

Source control module 210 may interact with source management system 260 to obtain source management data. Source management data may include characteristics of source code managed by source management system 260, where examples of characteristics are the last development participant to check out a source code file, the last time a source code file was checked in, comments entered by a development participant during check-in, related source code files, build information, etc. Further, build information may include a build timestamp, a version number, a change log, or other build characteristics. Source control module 210 may be configured to identify source code files that are related to an error by using the error data that is obtained as described above. After identifying the source code files, source control module 210 may obtain the source management data related to the source code files from source management system 260. The source management data 234 may be stored in storage device 230.

Issue tracking module 212 may interact with issue tracking system 270 to obtain issue tracking data. Issue tracking data may include issue entries that describe issues of an application, where an issue entry may include a description of an issue, detailed steps to reproduce the issue, an error code that is presented when the issue occurs (if applicable), a timestamp for when the issue occurred, etc. Based on error data obtained as described above, issue tracking module 212 may obtain issue tracking data from issue tracking system 270 that is relevant to source code files associated with a particular error that is described in the error data. The issue tracking data 236 may be stored in storage device 230. In this case, the issue tracking data 236 can be used to determine if the error data is associated with a preexisting issue entry. Issue tracking module 212 may also be configured to automatically create issue entries based on the error data if there is no preexisting issue entry.

Project management module 214 may interact with project management system 280 to obtain project management data. Project management data may include a project plan for development of an application, work assignments for development participants of the application, deadlines for features of the application, etc. Based on build information obtained as described above, project management module 214 may obtain project management data from project management system 290 that is relevant to a current build of the application. The project management data 238 may be stored in storage device 230.

Notification module 216 may manage notifications related to errors for software development participants. Although the components of notification module 216 are described in detail below, additional details regarding an example implementation of module 204 are provided above in connection with instructions 126-128 of FIG. 1.

Development context module 218 may generate development contexts from errors detected in an application provided by application server 290. A development context may include characteristics from the development environment of an application that are relevant to a particular error. The development context may provide a development participant with a detailed description of operating parameters of the application when the error occurred, which the development participant can then use address the error more effectively. Development context module 218 may use the error data from application server 290 to obtain development data (e.g., automated testing data 232, source management data 234, issue tracking data 236, project management data 238) for generating the development context for an error. Specifically, development context module 218 may identify source code files that are related to an error in a software application and then user the identified source code files to obtain the relevant development data for building the development context.

Code coverage module 220 may prepare code coverage information based on automated testing data that is obtained by automated testing module 208. The code coverage information may include code coverage statistics for the relevant source code files identified by development context module 218, where the code coverage statistics include the code coverage of code units (e.g., classes, functions, subroutines, etc.) in the source code files. The code coverage of the code units may allow a development participant to more easily identify problematic code units in the source code files so that the errors can be more quickly addressed. For example, the code coverage of each of the code units may be presented in a tabular format showing the classes in a source code file that are related to an error or exception along with the code coverage of each of the classes. In this example, classes with adequate coverage (i.e., code coverage exceeding a preconfigured threshold) may have a code coverage percentage shown in green while classes with inadequate coverage may have a code coverage percentage shown in red.

Notification module 222 may generate notifications related to errors for software development participants of the application. The notifications may provide access to a development context that is relevant to an error so that a software development participant may immediately begin addressing the error in response to receiving the notification. Notification module 222 may use source control module 210 to identify the software development participants that are related to an error by searching for development participants that performed check-ins of the relevant source code files for the relevant build of the application. Because the collection of development data and resulting generating of the development context is automated, notification module 222 may timely notify development participants of errors without the review of software testers, which reduces delays in the development cycle of the software application. This reduction in delays in especially useful for rapidly deployed applications such as web applications. Generated notifications may be stored as notification data 240 in storage device 230.

Storage device 230 may be any hardware storage device for maintaining data accessible to computing device 200. For example, storage device 230 may include one or more hard disk drives, solid state drives, tape drives, and/or any other storage devices. The storage devices may be located in computing device 200 and/or in another device in communication with computing device 200. As detailed above, storage device 230 may maintain automated testing data 232, source management data 234, issue tracking data 236, project management data 238, and notification data 240.

Application server 290 may provide various application(s) and/or service(s) accessible to user computing devices. Automated testing system 250 may be configured to perform automated testing (e.g., real user monitoring, automated testing scripts, etc.) on applications and/or services provided by application server 290. Source management system 260 may manage source code files that are compiled to generate the applications and/or services provided by application server 290. Issue tracking system 270 may manage issues (i.e., bugs) that are detected during the execution of applications and/or services provided by application server 290. Project management system 280 may provide functionality for managing the implementation of applications and/or services provided by application server 290 from a business perspective. In some cases, one or more of the development systems 250, 260, 270, 280 may be provided by a single server computing device or cluster of computing devices.

FIG. 3 is a flowchart of an example method 300 for execution by a computing device 100 for end user monitoring to automate issue tracking. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 may monitor an application in production to collect real user data. For example, computing device 100 may collect real-time exception data from users of the application, where the exception data describes error(s) that occur during the execution of the application. The application may be considered to be in production if it is deployed in an environment that is accessible by end users (i.e., actual users of the application as opposed to test users). In block 315, the source code files that are associated with the error(s) may be determined. Specifically, source management system may be consulted to identify the source code files based on the exception data. In this case, the exception data may describe the code units (e.g., classes, functions, etc.) that are currently being used or executed when the error(s) occur. Further, the development participants responsible for the deployed version (i.e., the development participants that performed the check-in that was compiled into the current build of the application) of the source code files may also be determined,

In block 320, code coverage of the identified source code files is determined. For example, the code coverage of each of the classes in the source code files may be determined and then prepared for presentation in a tabular format. In block 325, a notification of the error is sent to the responsible development participants of the source code files. The notification may include the exception data and the code coverage of each of the source code files. Method 300 may then proceed to block 330, where method 300 stops.

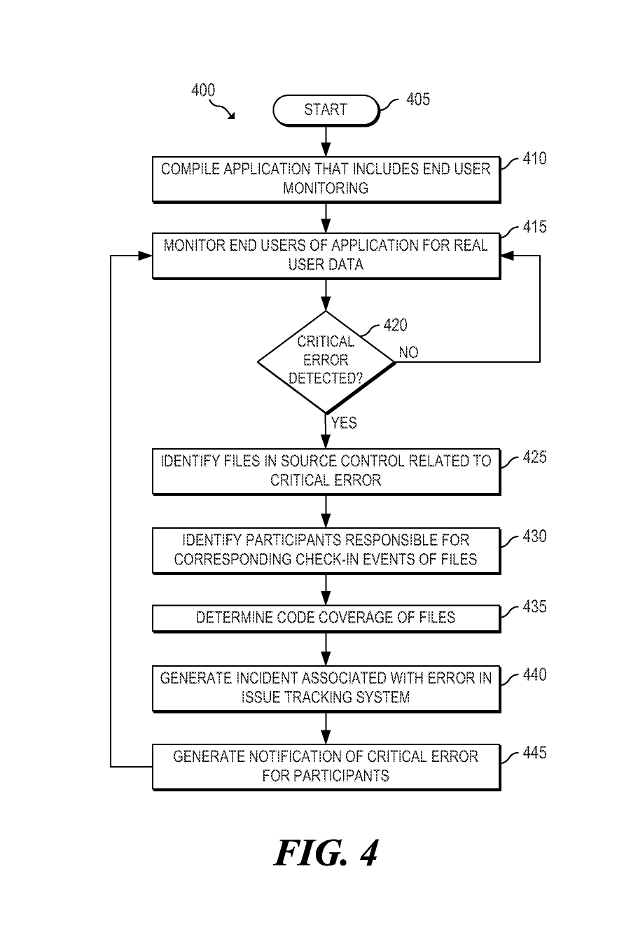

FIG. 4 is a flowchart of an example method 400 for execution by a computing device 200 for tracing source code for end user monitoring to automate issue tracking of a compiled software application. Although execution of method 400 is described below with reference to computing device 200 of FIG. 2, other suitable devices for execution of method 400 may be used, such as computing device 100 of FIG. 1. Method 400 may be implemented in the form of executable instructions stored on a machine-readable storage medium and/or in the form of electronic circuitry.

Method 400 may start in block 405 and proceed to block 410, where computing device 200 compiles a software application that includes end user monitoring. For example, source code files may be compiled to generate a software application with exception handling that monitors the execution of the application for errors and/or exceptions. In block 415, the end users of the application are monitored for real user data. Specifically, when an exception is thrown by the application, an error report including error data may be received from devices executing on behalf of the end users. For example, the application may present a prompt requesting that the end user submit the error report to computing device 200. The error data may include a description of the current state of the application that lists the functions and classes that are related to the exception or error. In another example, production logs of the application may be analyzed to obtain real user data. For example, log analytics may be used to determine (1) number of errors and/or warnings and (2) flow info (e.g., stack traces).

In block 420, it is determined whether a critical error is detected. Various criteria may be defined for determining whether an error or exception is critical. For example, critical errors may be identified as any error or exception that causes the application to crash. In another example, critical errors may be identified as any error that is unhandled. Alternatively, all detected errors may be considered to be critical errors (i.e., block 420 may be skipped such that method 400 proceeds directly to block 425).

In block 425, the source code files that are associated with the error may be determined. For example, source management system may be consulted to search for source code files based on the functions and classes in the error data. In block 430, the development participants responsible for the corresponding check-in events of the source code files may also be determined. In this example, the corresponding check-in events are the check-ins performed to create the version of the source code files used to compile the executing build of the application.

In block 435, code coverage of the identified source code files is determined. In block 440, an incident associated with the error is generated in an issue tracking system is generated. The incident may be generated as an issue entry in the system that describes the conditions that caused the error. For example, the actions performed immediately prior to the error may be captured by the user's device in block 415 and then included in the issue entry. In block 445, a notification of the error is sent to the responsible development participants of the source code files. The notification may include the error data, the code coverage of each of the source code files, and the issue entry. At this stage, method 400 may return to block 415, where computing device 415 continues to monitor the application.

The foregoing disclosure describes a number of example embodiments for end user monitoring to automate issue tracking. In this manner, the embodiments disclosed herein enable issues to be tracked automatically by monitoring and processing error data collected from end user devices, where the error data is augmented with development data from various development systems.

1. A system for end user monitoring to automate issue tracking, the system comprising:
a processor to:
monitor an application during production to collect real user data;
in response to detecting an error in the real user data, determine a plurality of source code files in a source management system that are associated with the error;
obtain a code coverage value for each of the plurality of source code files; and
send a notification of the error to a development participant that is responsible for a file of the plurality of source code files, wherein the notification comprises the code coverage for the file.

2. The system of claim 1, wherein the processor determines the plurality of source code files by:
identifying a check-in event of the source management system is related to the error based on a function of the plurality of source code files that was executing during the error, wherein the notification further comprises source management data for the check-in event.

3. The system of claim 2, wherein the notification further comprises build information for the application from the source management system.

4. The system of claim 2, wherein the processor is further to:
create an incident associated with the error in an issue tracking system of the application, wherein the incident comprises the development context for the check-in event.

5. The system of claim 3, wherein the processor is further to:
obtain project management data from a project management system based on the build information, wherein the notification further comprises the project management data.

6. The system of claim 1, wherein the code coverage value for each of the plurality of source code files is obtained from an automated testing system.

7. A method for end user monitoring to automate issue tracking, the method comprising:
monitoring an application during production to collect real user data;
in response to detecting an error in the real user data, determining a plurality of source code files in a source management system that are associated with the error;
obtaining a code coverage value for each of the plurality of source code files from an automated testing system; and
sending a notification of the error to a development participant that is responsible for a file of the plurality of source code files, wherein the notification comprises the code coverage for the file.

8. The method of claim 7, wherein determining the plurality of source code files further comprises:
identifying a check-in event of the source management system is related to the error based on a function of the plurality of source code files that was executing during the error, wherein the notification further comprises source management data for the check-in event.

9. The method of claim 8, wherein the notification further comprises build information for the application from the source management system.

10. The method of claim 8, further comprising:
creating an incident associated with the error in an issue tracking system of the application, wherein the incident comprises the development context for the check-in event.

11. The method of claim 3, further comprising:
obtaining project management data from a project management system based on the build information, wherein the notification further comprises the project management data.

12. A non-transitory machine-readable storage medium encoded with instructions executable by a processor for end user monitoring to automate issue tracking, the machine-readable storage medium comprising instructions to:
monitor an application during production to collect real user data;
in response to detecting an error in the real user data, obtain error data from the real user data that identifies a function that was executing during the error;
using the error data to determine a plurality of source code files in a source management system that are associated with the error;
obtain a code coverage value for each of the plurality of source code files from an automated testing system; and
send a notification of the error to a development participant that is responsible for a file of the plurality of source code files, wherein the notification comprises the error data and the code coverage for the file.

13. The machine-readable storage medium of claim 12, wherein determining the plurality of source code files further comprises:
identifying a check-in event of the source management system is related to the function, wherein the notification further comprises source management data for the check-in event.

14. The machine-readable storage medium of claim 13, further comprising instructions to:
create an incident associated with the error in an issue tracking system of the application, wherein the incident comprises the development context for the check-in event.

15. The machine-readable storage medium of claim 12, further comprising instructions to:
obtain build information for the application from the source management system; and
obtain project management data from a project management system based on the build information, wherein the notification further comprises the project management data.
